(19) United States
(12) Patent Application Publication
(10) Pub. No.: US 2012/0175187 A1
(43) Pub. Date: Jul. 12, 2012

(54) LADDER WITH GUARD RAIL

(76) Inventor: Russell Stuart Baker, Lydney Gloucestershire (GB)

(21) Appl. No.: 13/346,136

(22) Filed: Jan. 9, 2012

Related U.S. Application Data
(63) Continuation of application No. PCT/GB2010/051121, filed on Jul. 7, 2010.

(30) Foreign Application Priority Data
Jul. 10, 2009 (GB) 0912040.3

(51) Int. Cl. E06C 7/18; E04H 17/14

(52) U.S. Cl. 182/106; 256/59

(57) ABSTRACT

In a first aspect there is a combination hollow-runged ladder with guardrails in which the guardrails are connected to at least a pair of spaced-apart yokes, each yoke extending through a respective ladder rung, and locking means to lock each yoke and hence the guardrails in an outwardly extended position relative to the ladder side rails. A second aspect provides a guardrail assembly for attachment to a hollow-runged ladder, the assembly comprising a pair of guardrails, one for each side of the ladder, each guardrail being connected to at least a pair of guardrail supports, each guardrail support being adapted to fit within a respective ladder rung and including means by which it can be releasably secured thereto, the arrangement being such that respectively opposite guardrail supports and the rungs to which they are releasably attached collectively define a releasable yoke for supporting the pair of guardrails.

### CROSS-REFERENCE TO RELATED APPLICATIONS

This application is filed under 35 U.S.C. §120 and §365(c) as a continuation of International Patent Application No. PCT/GB2010/051121 filed Jul. 7 2010, which application claims priority from United Kingdom Patent Application No. 0912040.3 filed Jul. 10, 2009, which applications are incorporated herein by reference in their entireties.

### FIELD OF THE INVENTION

This invention relates to ladders, such as extendable ladders, made of metal, such as aluminium, and having hollow rungs. In particular, this invention relates to ladders for use in awkward situations, such as where a ladder has to lean over an obstruction such as a fence or outbuilding, sometimes at a shallower angle than is otherwise desirable, thereby increasing the risk of the ladder twisting and/or tools and materials being dropped in favor of the user of the ladder seeking a better grip on the rungs thereof.

### BACKGROUND OF THE INVENTION

Although it is possible to secure guardrails to each ladder side rail, which may for convenience be articulated so that the guardrail may lie substantially alongside a respective side rail when not in use and is folded outwards and locked in position for use, it will be understood that at every point where such a guardrail is connected to the ladder side rail, such as through rivets or bolts etc., it necessarily weakens the side rail and hence the ladder, more particularly if the fixings are large enough to ensure that the guardrail does not become detached when in use.

### BRIEF SUMMARY OF THE INVENTION

The present invention is derived from the realization that there is a need for guardrails which are substantially not connected directly to the ladder side rails or the ladder rungs, such that the ladder itself is substantially unaltered from its original condition and load bearing capacity.

According to a first aspect of the invention there is provided a combination hollow-runged ladder with guardrails in which the guardrails are connected to at least a pair of spaced-apart yokes, each yoke extending through a respective ladder rung, and locking means to lock each yoke and hence the guardrails in an outwardly extended position relative to the ladder side rails.

With this arrangement, both guardrails are supported by at least a pair of yokes which are substantially independent of the ladder other than each being “captured” by a respective ladder rung, instead of the guardrails being connected directly to the ladder side rails by driven fasteners, which necessarily weaken the ladder.

Conveniently, the guardrails are rigid and are swivellably connected to the yokes so that they can be articulated with the yokes from a stored position adjacent the side rails to an extended position away from but parallel to the side rails, in which case they may conveniently be releasably locked in this position by means of swivellable stay rods connected to the foot of the side rail by e.g. a pivot pin extending through the lowermost ladder rung and being resiliently receivable at their free end by means of a spring-biased latching mechanism on one or both of the arms of one of the yokes, such as the lowermost yoke.

Alternatively, the guardrails may be substantially flexible, such as being made of a cord, such as a metal or nylon cord or may be a combination of both rigid and flexible components.

Similarly, the locking mechanism for each yoke may instead be constituted by a cam-lock arrangement preventing rotation of a yoke within a respective ladder rung, such as by the use of a locking wheel or lever turned in one direction to release the cam lock and allow the yoke to be swiveled and turned in the other direction to allow the yoke to be locked in a desired position, such as a stored position for transport or an extended, open, position for use in supporting the guardrails.

According to a second aspect of the invention there is provided a guardrail assembly for attachment to a hollow-runged ladder, the assembly comprising a pair of guardrails, one for each side of the ladder, each guardrail being connected to at least a pair of guardrail supports, each guardrail support being adapted to fit within a respective ladder rung and including means by which it can be releasably secured thereto, the arrangement being such that respectively opposite guardrail supports and the rungs to which they are releaseably attached collectively define a releasable yoke for supporting the pair of guardrails.

Conveniently, the guardrail supports are generally ‘L’ shaped and are each pivotably connected at one end to a respective guardrail and include at the other, free, end locking means for releasably locking the free end within a respective ladder rung. Preferably, the locking means comprises a cam mechanism translating axial movement to radial movement to thereby releasably lock the mechanism and hence the guardrail support to the inside of the ladder rung. Conveniently, the cam mechanism comprises a threaded actuating rod extending from the elbow of the ‘L’ shaped guardrail support to its free end, the actuating rod including at that end a moveable cam surface co-operable with a fixed cam surface on the free end of the guardrail support in this region whereby rotation of the rod causes the moveable cam surface to ride up or down the fixed cam surface to thereby radially expand or contract the cam mechanism within the ladder rung.

### BRIEF DESCRIPTION OF THE DRAWINGS

The invention will now be described, by way of example only, with reference to the accompanying drawings in which:

FIG. 1 is a front view of a combination ladder and guardrail according to the invention;

FIG. 2 is a side view of the combination ladder with the guard rail in FIG. 1 shown in its stored position leaning against a post;

FIG. 3 is a side view of part of the combination ladder shown in FIG. 2 being opened for use;

FIG. 4 is a side view of the fully opened combination ladder of FIG. 2;

FIG. 5 is a detail view showing how the guardrails are connected to the ladder on yokes;

FIG. 6 is a perspective view of a guardrail assembly according to the second aspect of the invention shown attached to a hollow-runged ladder;

FIG. 7 is a side view of part of one of the guardrails shown in FIG. 6 showing the cam mechanism by which it may be releasably secured to the inside of one of the ladder rungs;

FIG. 8 is a part sectional view showing the free end of the guardrail support of FIG. 7 partially inserted within a ladder rung; and,

FIG. 9 is a view corresponding to that of FIG. 8 but showing the cam mechanism releasably securing the free end of the guardrail support within a ladder rung.

### DETAILED DESCRIPTION OF THE INVENTION

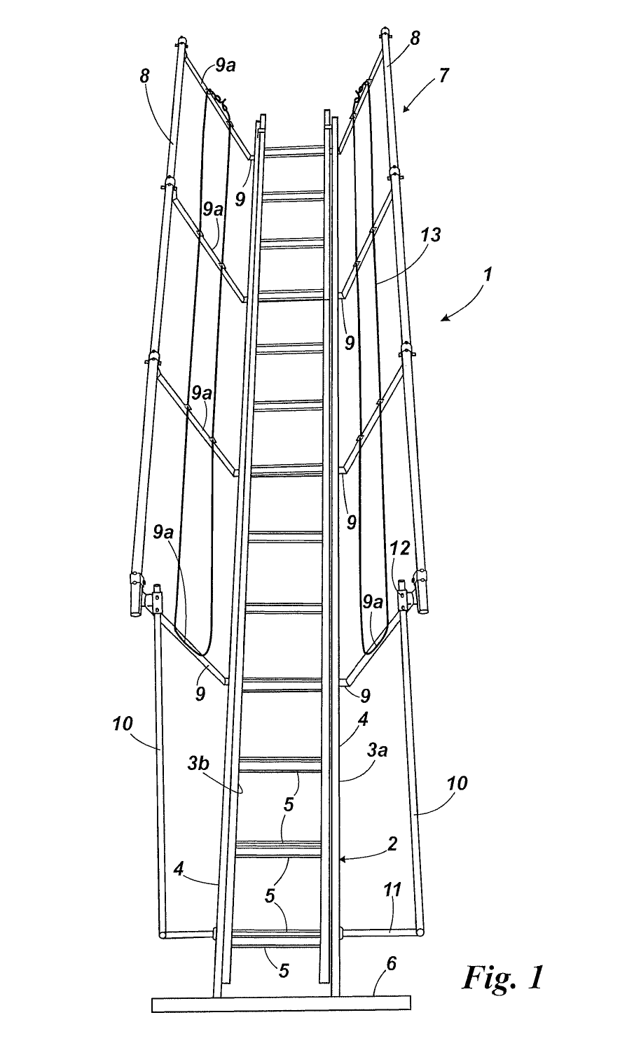

Referring firstly to FIG. 1, a combination ladder and guardrails is shown generally at 1 and comprises a conventional pair of extendable ladders shown generally at 2 comprising an outer ladder 3a having side rails 4 between which are disposed at spaced intervals respective sets of hollow rungs 5, and an inner ladder 3b, the outer ladder 3a also including at its lower end an elongated stabilizer 6, which may be permanently affixed or releasably securable thereto by any suitable fastener means.

The guardrails for the ladder 2 are shown generally at 7 and comprise a pair of guardrail banister posts 8 swivellably connected to, in this embodiment, a set of four spaced-apart yokes 9 with yoke arms 9a which are collectively held in their upright, open, position as shown by a pair of stay rods 10 connected at their lower ends to a stay rod pivot bar 11 which extends through the lowermost rung 5 of the outer ladder 3a. The otherwise free ends of the stay rods 10 are slideably secured on lockable sleeves 12 fixed to the lowermost yoke 9 at the otherwise free end of the yoke arms 9a. Extending along and between each guardrail 8 and side rail 4 is a flexible loop of cord 13, such as nylon or woven metal attached to the yoke arms 9a which provides additional safety for a user of the ladder 2.

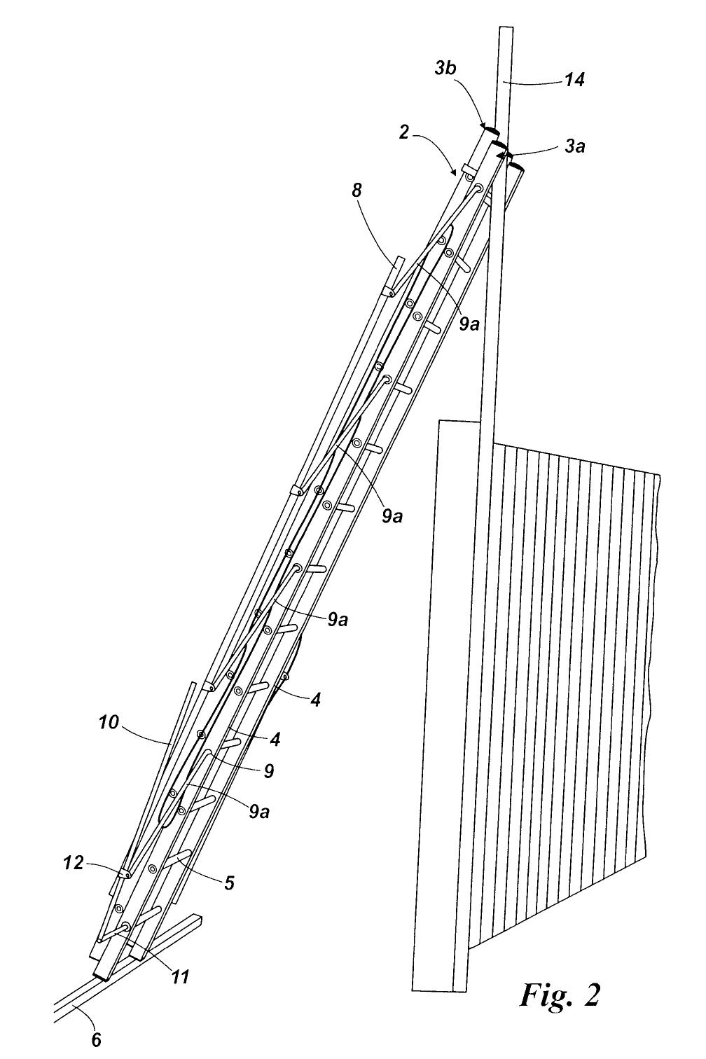

In FIG. 2 it will be seen that the pair of extendable ladders 2 are shown leaning against a post 14, in which position the guardrail banister posts 8 lie substantially flat against them with the free arms 9a of a set of four yokes 9 being swiveled to their closed position in which they may be releaseably locked by a suitable adjustment of the lockable sleeves 12 on the yoke arms 9a of the lowermost yoke 9.

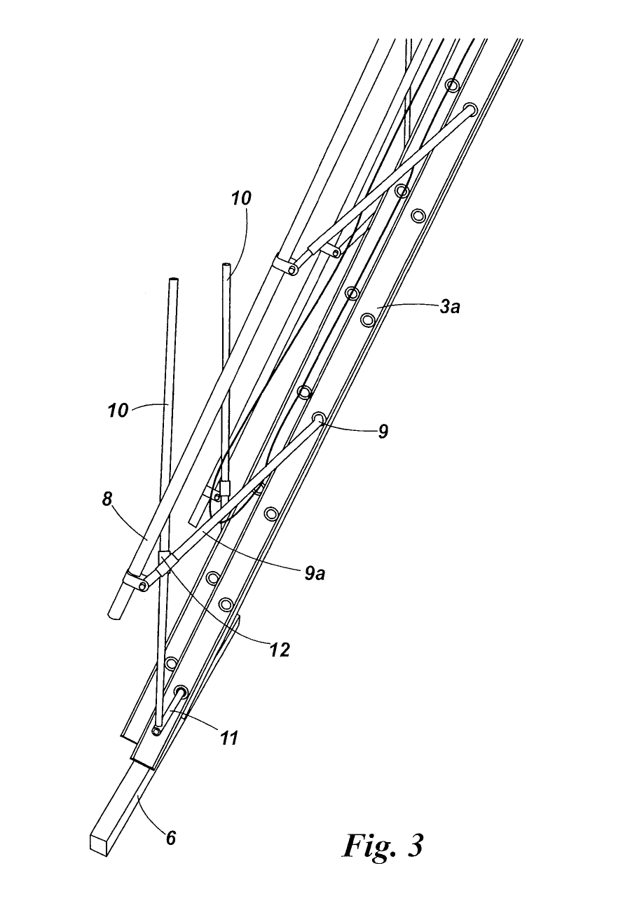

In FIG. 3 the lockable sleeves 12 have been unlocked to permit them to be slid upwardly on the pair of stay rods 10 and, because of the swivellable connection between the yokes 9 and the rungs 5 and the yokes 9 and the guardrail banister posts 8 they are trapezoidally moveable to the position shown, i.e., in a semi-open state.

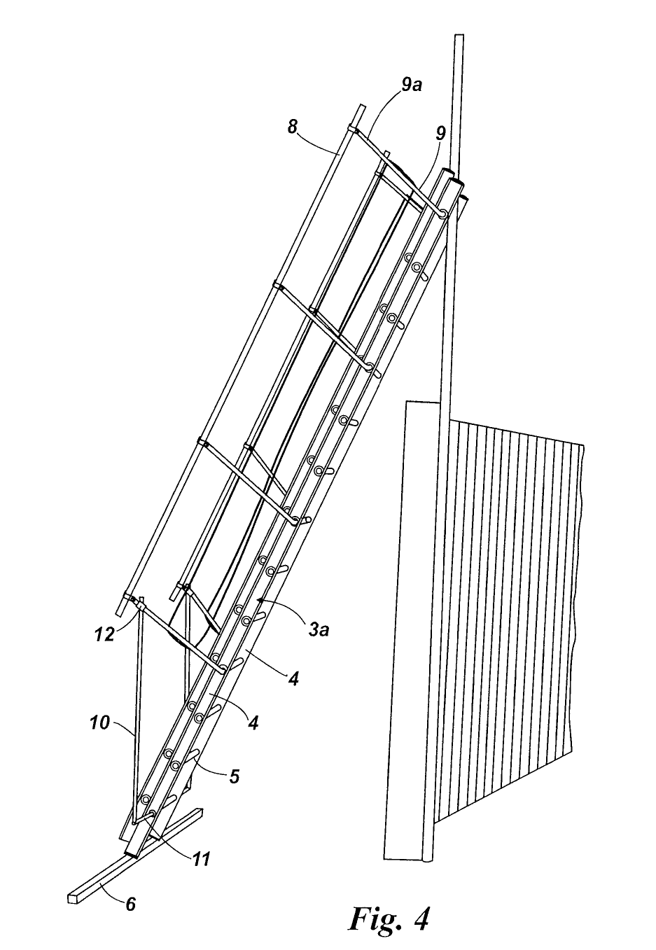

FIG. 4 shows the combination ladder and guardrails 1 in their fully assembled condition with the guardrail banister posts 8 fully opened and locked in that position by suitable tightening of the lockable sleeves 12 on the otherwise free ends of the stay rods 10.

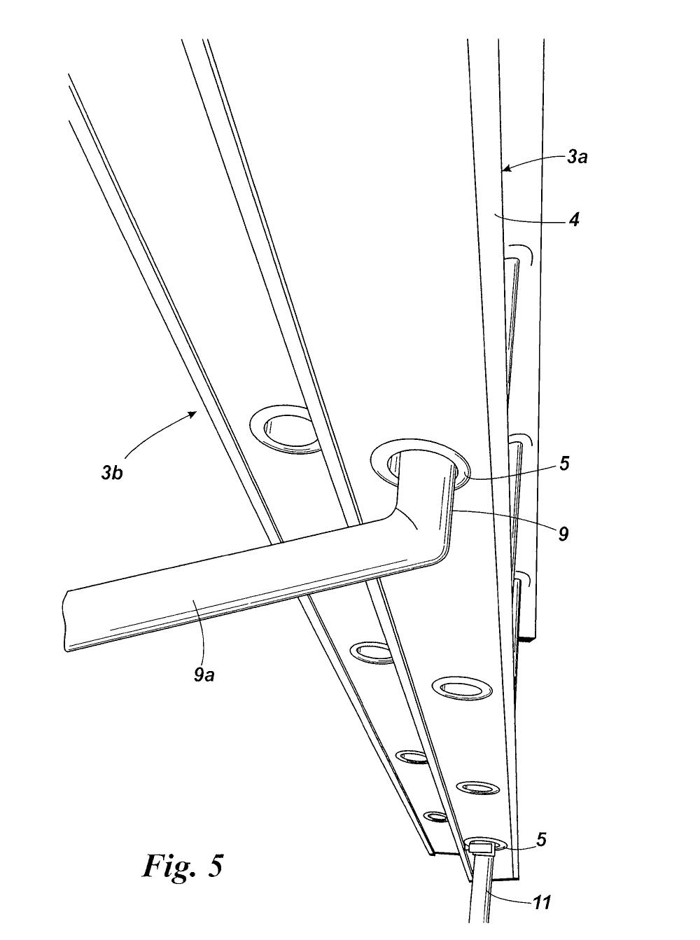

In FIG. 5 there is shown a detailed view of part of a yoke 9 showing how it is captured by a respective rung 5 extending through a side rail 4 of the outer ladder 3a. Similarly, the stay rod pivot bar 11 is shown extending through the lowermost rung 5 of the outer ladder 3a, which is otherwise untouched in terms of fixtures, fastenings or fittings that would otherwise be needed to provide the outer ladder 3a with a set of guardrails, thereby weakening the ladder and/or substantially increasing its weight if the fasteners are instead in the form of clamps, etc., which may themselves be difficult to fix to the guardrail banister posts or the rungs 5 without substantially impeding the ease of use of the pair of ladders 2.

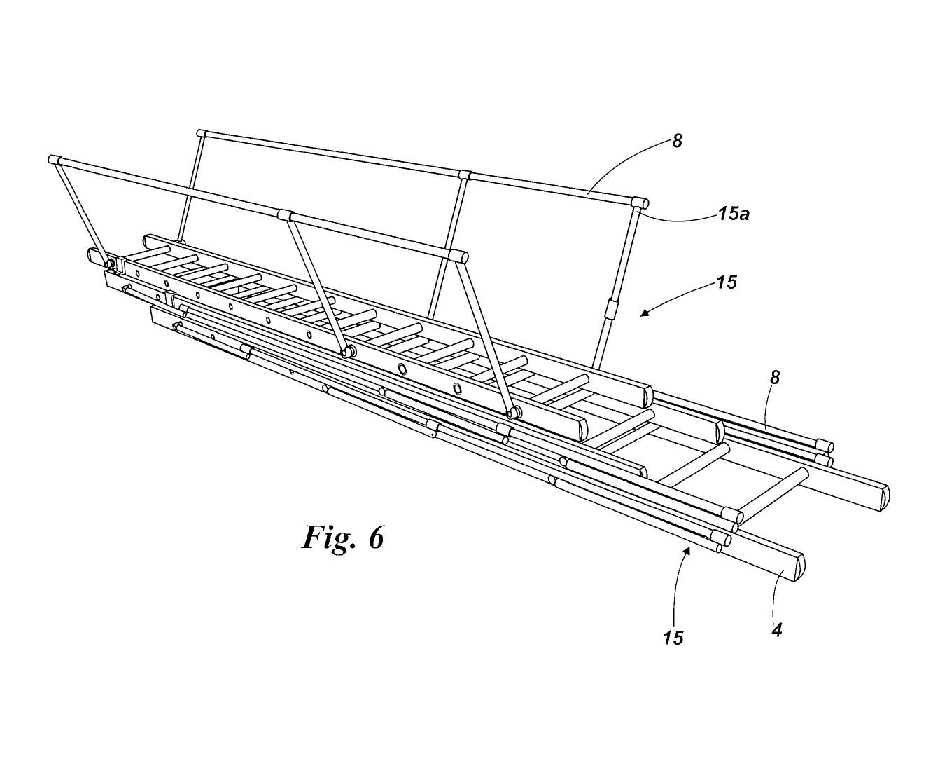

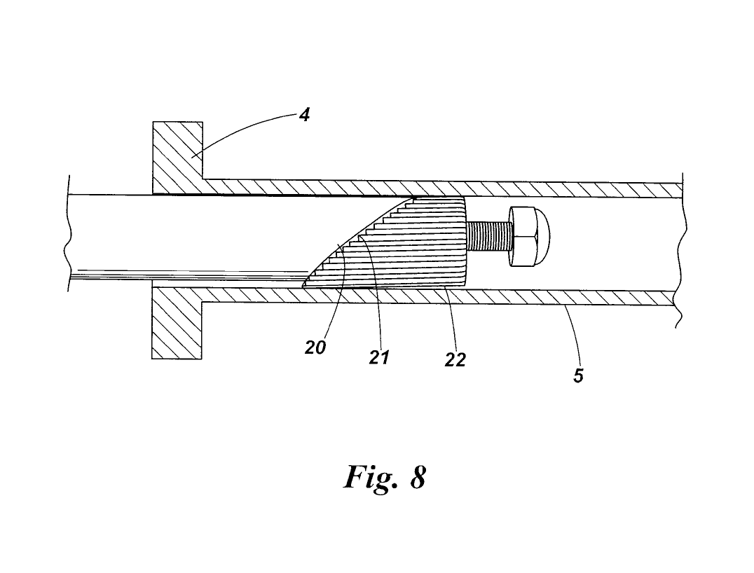

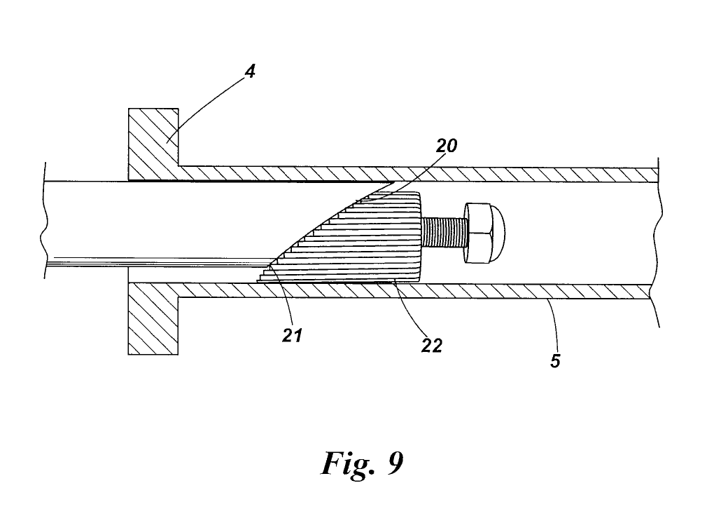

Turning now to FIGS. 6 to 9 there is shown a second aspect of the invention in which, instead of a plurality of yokes 9 with respectively opposite yoke arms 9a there is instead provided a plurality of guardrail supports shown generally at 15 of generally ‘L’ shape, each being swivelably connected at one end 15a to a respective part of a guardrail 8 and having a free, other, end 15b insertable within a respective rung 5 in the manner as shown in FIG. 8 and releasably securable therewithin in the manner as shown in FIG. 9.

FIG. 6 shows a three-section ladder in which certain of the guardrails 8 are shown in their stored position parallel to the side rails 4, with the uppermost ladder section shown with the guardrails 8 in their fully extended and locked, operational condition.

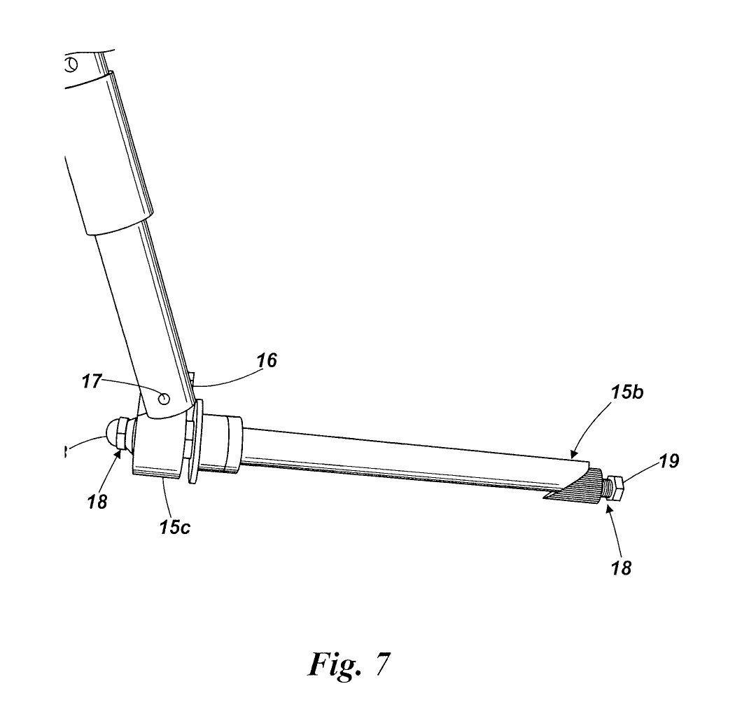

As can be seen more clearly with reference to FIG. 7, the guardrail support 15 is articulated at its elbow 15c by means of a tongue and groove swivel joint 16 which may be releasably locked in any chosen position via a grub screw 17. Also shown in FIG. 7 is a threaded actuator rod 18 extending through the elbow 15c up to and slightly beyond the free end 15b of the guardrail support 15, terminating in a stop member 19. The free end 15b of the guardrail support 15 has a fixed inclined cam surface 20 (shown more clearly with reference to FIG. 8) which is co-operable with a correspondingly shaped moveable cam surface 21 on a threaded, knurled bush 22 between the stop member 19 and the cam surface 20. The other end of the actuator rod 18 remote from the stop member 19 has a fixed hexagonal nut 23 by which it can be rotated to cause the bush 22 and its cam surface 21 to slide over the cam surface 20 at the free end 15b of the guardrail support 15 from a radially contracted position (relative to the inside of the rung 5) as shown in FIG. 8 in which the guardrail 15 is slideable and swivelable within the ladder rung 5 to the position shown in FIG. 9 whereby the cam surface 21 and hence bush 22 has been pulled axially towards the nut 23 by rotation thereof such that the entire assembly has become radially expanded in this region, thereby releasably locking the guardrail support 15 to the inside of the ladder rung 5.

The arrangement shown with reference to FIGS. 6 to 9 is particularly convenient because it allows for different widths of ladders and ladder sections to be catered for by essentially the same components, i.e., adjustable guardrail supports which can be expanded radially at each free end to securely lock these in place on respective sides of a hollow-runged ladder of virtually any size and shape.

What is claimed is:

1. A combination hollow-runged ladder with guardrails (1) in which the guardrails (7) are connected to at least a pair of spaced-apart yokes (9), each yoke extending through a respective ladder rung (5), and locking means (10) to lock each yoke and hence the guardrails in an outwardly extended position relative to the ladder side rails (4).

2. The combination recited in claim 1 wherein the guardrails (7) are rigid and are swivelably connected to the yokes (9) so that they can be articulated with the yokes from a stored position adjacent the side rails (4) to an extended position away from but parallel to the side rails.

3. The combination recited in claim 1 wherein the yokes (9) can be releasably locked in position by means of one or more swivelable stay rods (10) connected to the foot of the side rail (4).

4. The combination recited in claim 3 wherein each stay rod (10) is locked in position by a pivot pin (11) extending through the lowermost ladder rung (5) and being resiliently receivable at the or their free ends by means of a spring-biased latching mechanism (12) on one or both of the arms (9a) of one of the yokes (9), such as the lowermost yoke.

5. The combination recited in claim 1 wherein the guardrails (7) are substantially flexible, such as being made of a cord, such as a metal or nylon cord.

6. The combination recited in claim 1 wherein the guardrails (7) comprise a combination of rigid (8) and flexible (13) components.

7. The combination recited in claim 1 wherein the locking mechanism (11) for each yoke is constituted by a cam-lock arrangement preventing rotation of a yoke (9) within a respective ladder rung.

8. The combination recited in claim 7 wherein the cam lock arrangement (11) is in the form of a locking wheel or lever turned in one direction to release the cam lock and allow the yoke (9) to be swiveled and turned in the other direction to allow the yoke to be locked in a desired position, such as a stored position for transport or an extended, open, position for use in supporting the guardrails.

9. A guardrail assembly (8, 15) for attachment to a hollow-runged ladder (4), the assembly comprising a pair of guardrails (8), one for each side of the ladder, each guardrail being connected to at least a pair of guardrail supports (15), each guardrail support being adapted to fit within a respective ladder rung (5) and including means by which it can be releasably secured thereto (15b, 18), the arrangement being such that respectively opposite guardrail supports and the rungs to which they are releasably attached collectively define a releasable yoke (5, 15) for supporting the pair of guardrails.

10. The guardrail assembly recited in claim 9 wherein the guardrail supports (15) are generally ‘L’ shaped and are each pivotably connected at one end (15a) to a respective guardrail (8) and include at the other, free end (15b) locking means (21, 22) for releasably locking the free end within a respective ladder rung.

11. The guardrail assembly recited in claim 10 wherein the locking means (21, 22) comprises a cam mechanism translating axial movement to radial movement to thereby releasably lock the mechanism and hence the guardrail support (15) to the inside of the ladder rung (5).

12. The guardrail assembly recited in claim 11 wherein the cam mechanism comprises a threaded actuating rod (18) extending from the elbow (15a) of the ‘L’ shaped guardrail support (15) to its free end (15b), the actuating rod including at that end a moveable cam surface (21) co-operable with a fixed cam surface (20) on the free end of the guardrail support (15) in this region whereby rotation of the rod causes the moveable cam surface to ride up or down the fixed cam surface to thereby radially expand or contract the cam mechanism within the ladder rung (5).
